(19) United States
(12) Patent Application Publication
(10) Pub. No.: US 2022/0384887 A1
(43) Pub. Date: Dec. 1, 2022

(54) BATTERY CASE AND MANUFACTURING METHOD OF BATTERY CASE

(71) Applicant: TOYOTA JIDOSHA KABUSHIKI KAISHA, Toyota-shi (JP)

(72) Inventors: Shintaro UTSUMI, Susono-shi (JP); Yuya Kumasaka, Susono-shi (JP); Shunsuke Nagata, Nagakute-shi (JP); Kento Masumura, Toyota-shi (JP)

(73) Assignee: TOYOTA JIDOSHA KABUSHIKI KAISHA, Toyota-shi (JP)

(21) Appl. No.: 17/752,926

(22) Filed: May 25, 2022

(30) Foreign Application Priority Data
Jun. 1, 2021 (JP) 2021-092396

(51) Int. Cl. H01M 50/209; H01M 50/231

(52) U.S. Cl. CPC H01M 50/209; H01M 50/231

(57) ABSTRACT

A battery case configured to accommodate one or a plurality of battery cells, and includes a metal plate portion and a resin portion. The metal plate portion is made up of a plurality of metal plates that is part of the battery case. The resin portion that is another part of the battery case connects the metal plates by being interposed between the metal plates. The metal plates include a first metal plate and a second metal plate. The first metal plate includes a first overlapping portion and the second metal plate includes a second overlapping portion, the first overlapping portion and the second overlapping portion being overlapped with each other across the resin portion. The first overlapping portion includes one or more contact protrusions protruding toward the second overlapping portion. The second overlapping portion is in direct contact with the one or more contact protrusions.

### CROSS-REFERENCE TO RELATED APPLICATION

This application claims priority to Japanese Patent Application No. 2021-092396 filed on Jun. 1, 2021, incorporated herein by reference in its entirety.

### BACKGROUND

### 1. Technical Field

The present disclosure relates to a battery case and a manufacturing method of the battery case.

### 2. Description of Related Art

Japanese Unexamined Patent Application Publication No. 2020-129474 (JP 2020-129474 A) discloses a battery case for accommodating stacked battery cells. The battery case includes a metal case member and a resin case member provided covering the metal case member from the outside. The metal case member is formed in a box shape by bending a single metal plate. The resin case member is formed by injection molding with resin, and is fixed to and integrated with the metal case member.

### SUMMARY

In a battery case formed by combining a metal plate and a resin member, as in the battery case described in JP 2020-129474 A, it is conceivable to employ a configuration including a metal plate portion made of a plurality of metal plates, and a resin portion for connecting the metal plates, in order to increase the degree of freedom in shape. Now, the battery case installed in a vehicle needs to be grounded so that a battery pack and a vehicle body have the same potential. However, a configuration in which each of the metal plates is grounded, requires a plurality of ground lines. This leads to an increase in costs and wasteful structure.

The present disclosure provides a battery case capable of being grounded without providing a ground line for each metal plate, and a method for manufacturing the battery case.

A battery case according to one aspect of the present disclosure is configured to accommodate one or a plurality of battery cells, and includes a metal plate portion and a resin portion. The metal plate portion is made up of a plurality of metal plates that is part of the battery case. The resin portion is another part of the battery case connects the metal plates by being interposed between the metal plates. The metal plates include a first metal plate, and a second metal plate. The first metal plate includes a first overlapping portion and the second metal plate includes a second overlapping portion, the first overlapping portion and the second overlapping portion being overlapped with each other across the resin portion. The first overlapping portion includes one or more contact protrusions protruding toward the second overlapping portion. The second overlapping portion is in direct contact with the one or more contact protrusions.

The second overlapping portion may be a portion provided by bending part of the second metal plate such that the second overlapping portion is in contact with the one or more contact protrusions. A height of each of the one or more contact protrusions may be larger than a gap between the first overlapping portion and the second overlapping portion, such that the second overlapping portion rides up on the one or more contact protrusions.

The battery case may include an engaged structure in which the first metal plate and the resin portion are mechanically engaged, the engaged structure being configured to strengthen joining between the first metal plate and the resin portion. The engaged structure may include one or more protrusions provided on the first metal plate, and the one or more protrusions may be the one or more contact protrusions.

Each of the one or more contact protrusions may be a portion in which part of the first overlapping portion is raised.

Each of the one or more contact protrusions may be a portion provided by folding back part of the first overlapping portion.

The first metal plate and the second metal plate may be disposed away from each other, except for one or more positions of the one or more contact protrusions.

Each of the one or more protrusions may include an opening, and the resin portion may be filled inside of each of the one or more protrusions.

A manufacturing method of a battery case according to one aspect of the present disclosure is a manufacturing method of the battery case configured to accommodate one or a plurality of battery cells. The battery case includes a metal plate portion made up of a plurality of metal plates that is part of the battery case, and a resin portion that is another part of the battery case, and connects the metal plates by being interposed between the metal plates. The metal plates include a first metal plate, and a second metal plate. The first metal plate includes a first overlapping portion and the second metal plate includes a second overlapping portion, the first overlapping portion and the second overlapping portion being overlapped with each other across the resin portion. The first overlapping portion includes one or more contact protrusions protruding toward the second overlapping portion. The second overlapping portion is in direct contact with the one or more contact protrusions. The manufacturing method includes a press molding step of molding the metal plates by press molding, a protrusion forming step of molding the one or more contact protrusions by press molding, a setting step of setting the metal plates in a mold following the press molding step and the protrusion forming step, and an injection molding step of fabricating the battery case by filling in between the metal plates set in the mold with resin to mold the resin portion.

In the manufacturing method of the battery case, the first metal plate and the second metal plate may be disposed away from each other, except for one or more positions of the one or more contact protrusions.

In the battery case according to one aspect of the present disclosure, the first metal plate and the second metal plate included in the metal plates connected across the resin portion respectively include the first overlapping portion and the second overlapping portion. The second overlapping portion is in direct contact with the one or more contact protrusions of the first overlapping portion. This enables electrical conduction to be formed between the first metal plate and the second metal plate. Accordingly, when each pair of adjacent metal plates among the metal plates satisfies the relation between the first metal plate and the second metal plate, electrical conduction can be formed between the metal plates. Thus, grounding can be performed without providing a ground line for each metal plate.

Also, in the manufacturing method of the battery case according to one aspect of the present disclosure, the one or more contact protrusions are formed by press molding. Accordingly, the one or more contact protrusions can be formed simply by adding the protrusion forming step by press molding to the first metal plate formed by the press molding. Accordingly, a battery case in which contact between the metal plates can be secured can be manufactured, while suppressing addition of manufacturing steps.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a top view of a battery pack including a battery case according to a first embodiment;

FIG. 2 is a perspective view of the battery case according to the first embodiment;

FIG. 3 is a disassembled perspective view of a metal plate portion illustrated in FIG. 2;

FIG. 4 is a cross-sectional view taken along line IV-IV in FIG. 2;

FIG. 5 is a cross-sectional view taken along line V-V in FIG. 2;

FIG. 6A is an enlarged perspective view of the battery case for describing a contact structure according to the first embodiment;

FIG. 6B is a perspective cross-sectional view of the battery case including a cross-section taken along line VIB-VIB in FIG. 6A, for describing the contact structure according to the first embodiment;

FIG. 7 is a flowchart showing procedures of a manufacturing method of the battery case according to the first embodiment;

FIG. 8A is a supplementary diagram regarding formation of a contact protrusion, and realization of a contact structure between metal plates across the contact protrusion;

FIG. 8B is a supplementary diagram regarding formation of the contact protrusion, and realization of the contact structure between metal plates across the contact protrusion;

FIG. 8C is a supplementary diagram regarding formation of the contact protrusion, and realization of the contact structure between metal plates across the contact protrusion;

FIG. 9A is a diagram for describing a technique for forming a contact protrusion according to a second embodiment;

FIG. 9B is a diagram for describing the technique for forming the contact protrusion according to the second embodiment; and

FIG. 9C is a diagram for describing the technique for forming the contact protrusion according to the second embodiment.

### DETAILED DESCRIPTION OF EMBODIMENTS

In embodiments described below, elements that are common in the drawings are denoted by the same reference signs, and repetitive description will be omitted or simplified. Also, when a count, a quantity, an amount, a range, or the like, of each element, is stated in the following embodiments, the technical idea of the present disclosure is not limited to the stated number unless otherwise specified in particular, or when obviously limited to the stated number in principle. Also, configurations and the like described in the following embodiments are not necessarily essential to the technical idea of the present disclosure, unless otherwise specified in particular or when obviously limited thereto in principle.

### 1. First Embodiment

### 1-1. Battery Case Configuration

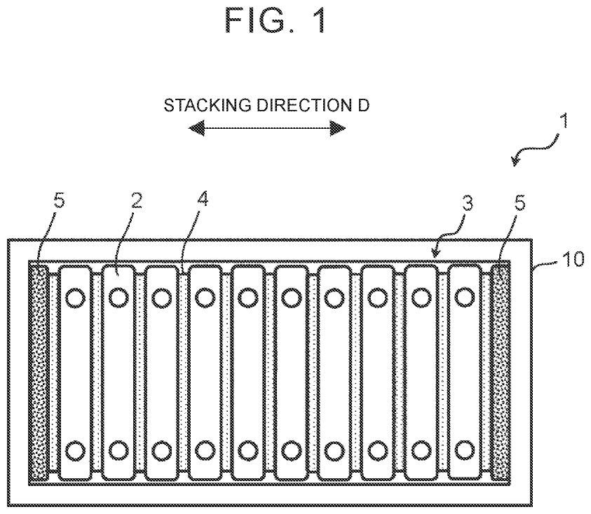

FIG. 1 is a top view of a battery pack 1 including a battery case 10 according to a first embodiment. The battery pack 1 includes a battery stack 3 which is a stacked body of multiple battery cells 2 that are stacked, and a battery case 10 that accommodates the battery stack 3. The battery pack 1 is installed in an electrified vehicle and supplies electric power to the electrified vehicle.

More specifically, in the example illustrated in FIG. 1, the battery stack 3 is configured by alternately stacking the battery cells 2 that are square in shape and spacers (resin frames) 4, and includes a pair of end plates 5 arranged so as to sandwich the assembly of the battery cells 2 and the spacers 4 from both sides in a stacking direction D. The spacers 4 are formed of an electrically insulating resin, and secure electrical insulating properties of adjacent battery cells 2, as well as functioning as heat dissipation paths for the battery cells 2. The battery stack 3 configured thus is accommodated in the battery case 10, in a state in which a compressive load is applied from the sides by the end plates 5 located at both ends thereof. Note that the number of battery cells 2 accommodated in the battery case 10 does not necessarily have to be a plurality, and may be one. Further, the “battery case” according to one aspect of the present disclosure may be formed so as to accommodate two rows or more, i.e., multiple battery stacks, arranged side by side.

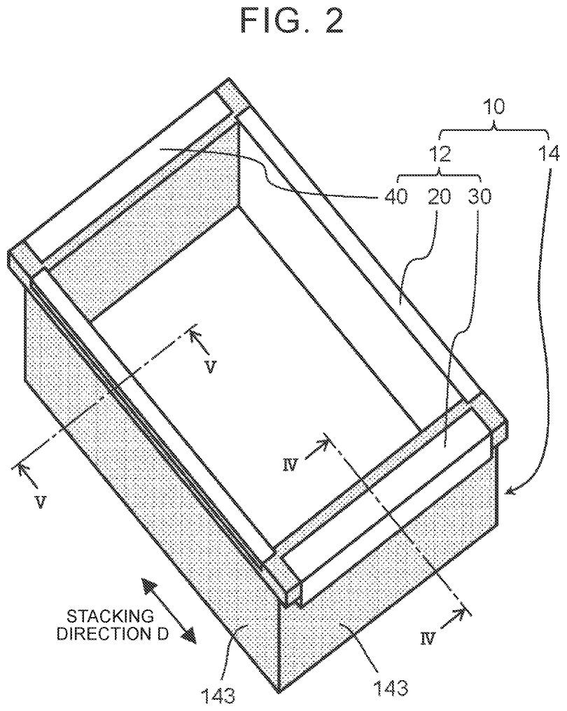

FIG. 2 is a perspective view of the battery case 10 according to the first embodiment. The battery case 10 has a substantially cuboid shape, and is configured of an upper cover (omitted from illustration) making up a top face of the battery case 10, and a lower case making up a bottom face and four side faces. FIG. 2 illustrates the lower case of the battery case 10. That is to say, the lower case has a substantially cuboid shape with an open top.

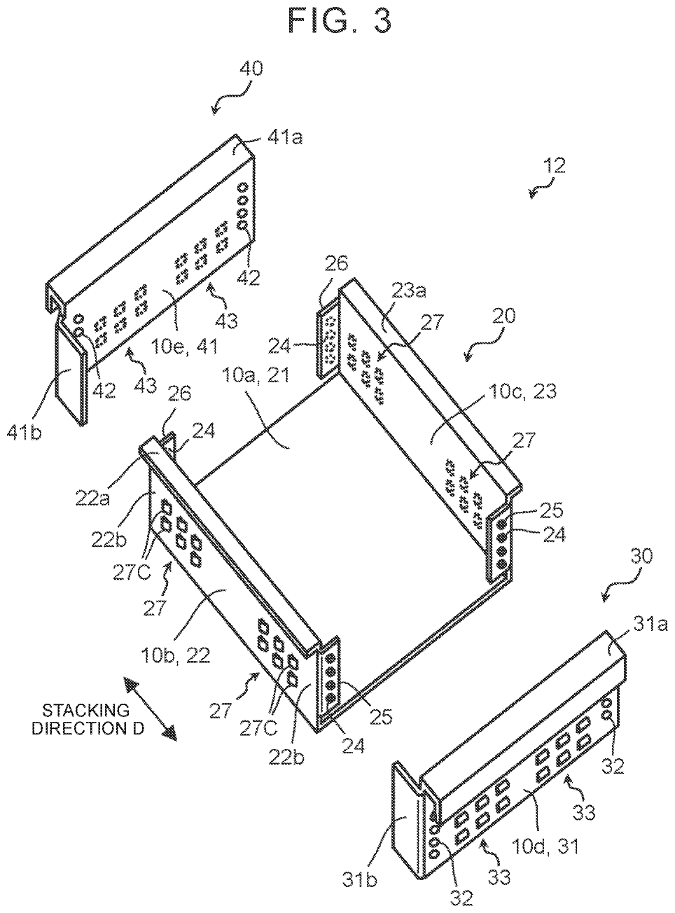

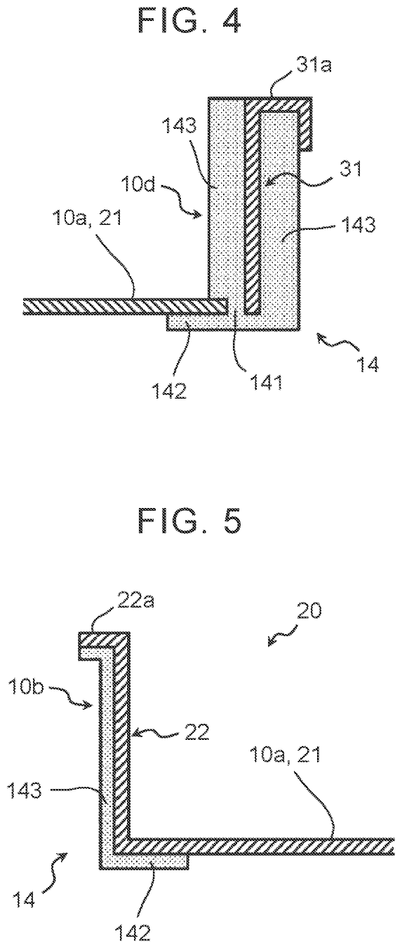

The configuration of the battery case 10 (lower case) will be described with reference to FIGS. 3 to 5, along with FIG. 2. The battery case 10 (lower case) is configured of a metal plate portion 12 and a resin portion 14. FIG. 3 is a disassembled perspective view of the metal plate portion 12 illustrated in FIG. 2. FIG. 4 is a cross-sectional view taken along line IV-IV in FIG. 2. FIG. 5 is a cross-sectional view taken along line V-V in FIG. 2.

As illustrated in FIG. 3, the metal plate portion 12 is made up of a plurality of (e.g., three) metal plates 20, 30, and 40. Examples of the material of the metal plate 20 and so forth include a steel plate, a galvanized steel plate, a nickel-plated steel plate, a stainless steel plate, and an aluminum plate, although not limited in particular thereto.

As illustrated in FIGS. 2, 3, and 5, the metal plate 20 includes a bottom wall portion 21 making up a bottom face 10a of the battery case 10, and a pair of side wall portions 22 and 23 making up a pair of side faces 10b and 10c facing each other. More specifically, the bottom wall portion 21 and the side wall portions 22 and 23 each have a rectangular basic shape. Each of the side wall portions 22 and 23 is erected extending upward from the bottom wall portion 21 in the battery case 10. Also, ends of the side wall portions 22 and 23 opposite to the bottom wall portion 21 are bent by 90 degrees, in order to increase the rigidity of the side wall portions 22 and 23. Accordingly, flange portions 22a and 23a, each having an L-shaped cross-section, are formed.

As illustrated in FIGS. 2, 3, and 4, the metal plate 30 primarily includes a side wall portion 31 making up a side face 10d of the battery case 10. More specifically, the side wall portion 31 has a rectangular basic shape. As illustrated in FIG. 4, the side wall portion 31 is separated from the bottom wall portion 21 of the metal plate 20, but is erected extending upward from the side of the bottom wall portion 21 in the battery case 10. Also, the end of the side wall portion 31 opposite to the bottom wall portion 21 is doubly bent by 90 degrees, in order to increase the rigidity of the side wall portion 31. As a result, a flange portion 31a having a U-shaped cross-section is formed.

The metal plate 40 includes a side wall portion 41 making up a side face 10e, facing the side face 10d made up of the side wall portion 31 of the metal plate 30 in the battery case 10. As an example, the metal plate 40 has the same shape as the metal plate 30. That is to say, the metal plate 40 has a flange portion 41a with the same shape as the flange portion 31a. Also, the metal plate 40 has through holes 42, an overlapping portion 41b, and protrusions 43, which have the same shapes as later-described through holes 32, an overlapping portion 31b, and protrusions 33 of the metal plate 30.

As can be seen from the cross-sectional view in FIG. 4, the three metal plates 20, 30, and 40 described above are not in direct contact with each other even in the completed state of the battery case 10 (lower case) illustrated in FIG. 2, and are disposed apart from each other (except for the positions of later-described contact protrusions 27C, which are a feature structure of the battery case 10 according to the present embodiment).

The metal plates 20, 30, and 40 are joined by the resin portion 14. Examples of the material of the resin portion 14 include a thermoplastic resin such as polyamide, a thermosetting resin such as epoxy, and a fiber reinforced plastic such as glass fiber reinforced polyamide, although not limited in particular thereto. As illustrated in FIGS. 2 and 4, the resin portion 14 is interposed between the three metal plates 20, 30, and 40, and connects the metal plates 20, 30, and 40.

More specifically, the resin portion 14 is formed as follows in order to hold the three metal plates 20, 30, and 40. That is to say, as illustrated in FIG. 4, in order to hold the bottom wall portion 21 of the metal plate 20 and the side wall portion 31 of the metal plate 30 in a separated state, the resin portion 14 has an interposing resin portion 141 interposed between the bottom wall portion 21 and the side wall portion 31. This also applies to the relation between the metal plate 20 and the metal plate 40.

Further, as illustrated in FIGS. 2, 4, and 5, the resin portion 14 has a box-shaped portion that covers each of the bottom face 10a and the four side faces 10b to 10e of the battery case 10, covering each of the metal plates 20, 30, and 40 from the outside of the battery case 10. A bottom wall resin portion 142 illustrated in FIGS. 4 and 5, and a square tubular side wall resin portion 143 illustrated in FIGS. 2, 4, and 5, correspond to the box-shaped portion here. By having such a box-shaped portion, the resin portion 14 can handle reaction force of the compressive load applied to the battery stack 3 described above, and external force acting from the outer side of the battery case 10 as to each of the side faces 10b to 10e of the battery case 10, along with the metal plate portion 12. A predetermined number of brackets (omitted from illustration) for fixing the battery case 10 to a vehicle body are fastened to, for example, nuts (omitted from illustration) press-fitted into the resin portion 14 (e.g., the side wall resin portion 143).

As described above, the resin portion 14 not only has a function of connecting the metal plate portion 12 (metal plates 20, 30, and 40) forming the basic framework of the battery case 10, but also functions as a part of the battery case 10, contributing to securing the rigidity and strength of the battery case 10. In the examples illustrated in FIGS. 4 and 5, the resin portion 14 covers only the edge portion of the bottom face 10a, but instead of such an example, the resin portion 14 may cover the entire bottom face 10a on the outside of the bottom wall portion 21.

The battery case 10 is provided with the following “engaged structure” in order to ensure fixing (joining) between each of the metal plates 20, 30, and 40 and the resin portion 14. The engaged structure as used here is a structure for strengthening the joining of the metal plate 20 and so forth and the resin portion 14 by mechanically engaging these members without using adhesive.

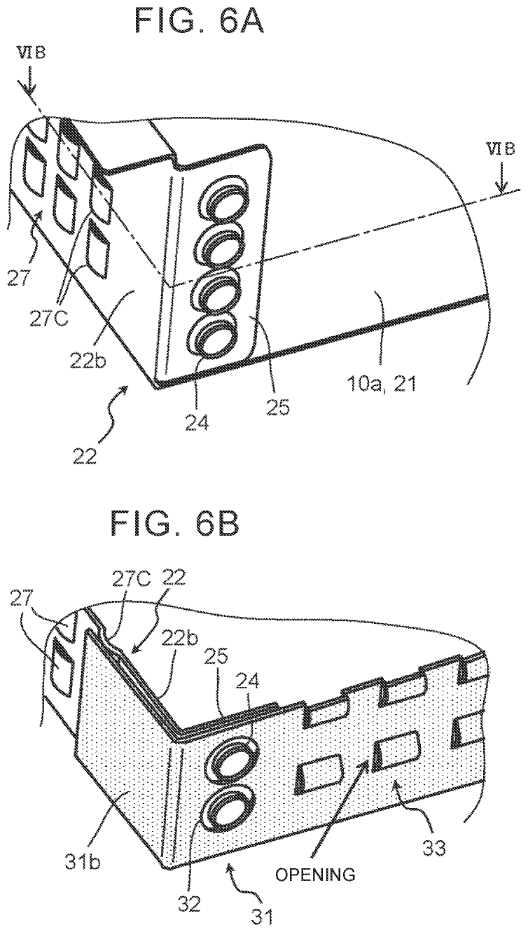

Specifically, the engaged structure is realized by, for example, a combination of protrusions 24 formed on the metal plate 20 and the through holes 32 and 42 formed in the metal plates 30 and 40, respectively. As illustrated in FIG. 3, the metal plate 20 includes facing wall portions 25 and 26 corresponding to the side wall portions 31 and 41, respectively. The facing wall portions 25 and 26 are formed by bending part of the side wall portions 22 and 23. The protrusions 24 are formed on the facing wall portions 25 and 26. The protrusions 24 have cylindrical shapes that protrude toward the side wall portions 31 or 41, as illustrated in later-described FIGS. 6A and 6B. The protrusions 24 pass through the through holes 32 or 42 without coming into contact with the through holes 32 or 42. The gaps between the facing wall portions 25 or 26 including the protrusions 24 and the side wall portions 31 or 41 are filled with the resin portion 14. According to the engaged structure using such cylindrical protrusions 24 and the through holes 32 and 42, wall portions of the resin portion 14 can be securely fixed (joined) to the metal plate 20 and so forth as compared with when being formed so as to simply come into contact with a flat face portion such as the metal plate 20 and so forth, and accordingly, the metal plate 20 and each of the metal plates 30 and 40 can be more reliably fixed (joined) across the resin portion 14.

The engaged structure is also realized by, for example, arch-shaped protrusions 27, 33, and 43. As illustrated in FIG. 3, the protrusions 27 are provided on each of the side wall portions 22 and 23, and the protrusions 33 and 43 are provided on the side wall portion 31 and the side wall portion 41, respectively. The arch-shaped protrusions 27, 33, and 43 as used here are open at both sides of the arch portions, as illustrated in FIGS. 6A and 6B, which will be described later. Accordingly, the insides thereof are filled with the resin portion 14. Thus, the metal plate 20 and so forth, and the resin portion 14 can be engaged well. That is to say, the engaged structure can be considered to include the protrusions 27, 33 and 43, for example. Accordingly, each of the metal plates 20, 30, and 40, and the resin portion 14 can be more reliably fixed (joined) by the engaged structure using the arch-shaped protrusions 27 and the like, as well, as compared with when the wall portion of the resin portion 14 is formed so as to simply come into contact with a flat face portion such as the metal plate 20 and so forth.

According to the battery case 10 formed by combining the metal plates 20 and so forth and the resin portion 14 as described above, the degree of freedom in the form of the case can be increased as compared with an example in which a battery case is made up of a combination of a metal case member formed in a box shape by bending one metal plate, and a holding member.

Now, grounding the battery case and the vehicle body so as to have the same potential is necessary, in order to guarantee electromagnetic compatibility (EMC) of the battery pack. However, in the basic configuration in which a metal plate portion made up of the metal plates is joined across the resin portion, contact and conductivity between the metal plates is not secured, and a ground line may be required for each of the metal plates. This leads to an increase in the number of parts and manufacturing man-hours of the battery case, which leads to increase in costs and structural waste.

### 1-1-1. Contact Structure Between Metal Plates

In view of the above problems, the battery case 10 according to the present embodiment has the following contact structure. FIGS. 6A and 6B are enlarged perspective views of the battery case 10 for describing a contact structure according to the first embodiment. More specifically, FIG. 6A illustrates an enlarged view of the shape at an end of the side wall portion 22 toward the side of the side wall portion 31, and FIG. 6B is a perspective cross-sectional view of the side wall portions 22 and 31 taken along line VIB-VIB in FIG. 6A.

The side wall portion 22 of the metal plate 20 and the side wall portion 31 of the metal plate 30 are provided with overlapping portions 22b and 31b, respectively, which are overlapped with each other across the resin portion 14. The overlapping portions 22b include “contact protrusions” that project toward the overlapping portion 31b. As an example, in the present embodiment, part of multiple arch-shaped protrusions 27 provided on the side wall portion 22 of the metal plate 20 for the above-described engaged structure serve as contact protrusions in the contact structure, as illustrated in FIGS. 6A and 6B. Accordingly, in the following description, the protrusions 27 serving as contact protrusions will be referred to as “contact protrusions 27C”.

The overlapping portion 31b on the metal plate 30 side is in direct contact with the contact protrusions 27C (i.e., not across the resin portion 14). Thus, the metal plate 20 and the metal plate 30 are in direct contact with each other via the contact protrusions 27C (i.e., only at portions in which the contact protrusions 27C are provided).

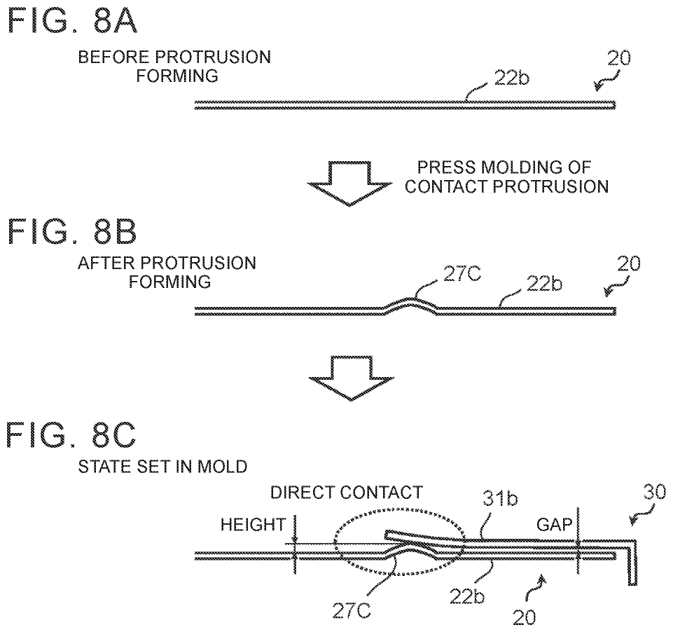

More specifically, in the example illustrated in FIGS. 6A and 6B, the overlapping portion 31b on the metal plate 30 side is a portion provided by bending a part of the side wall portion 31 of the metal plate 30 for contact with the contact protrusions 27C (i.e., an extended portion). The overlapping portion 31b is press-molded into a flat plate shape so as to be overlapped on the overlapping portion 22b, while having a gap between itself and the overlapping portion 22b that is filled in by the resin portion 14, by bending part of the side wall portion 31 by 90 degrees. In addition, the height of the contact protrusions 27C is set so as to be larger than the gap between the overlapping portion 22b and the overlapping portion 31b, such that the overlapping portion 31b will ride up on the contact protrusion 27C in the state of being set in a mold in a later-described setting step S4 (see FIGS. 8A, 8B, and 8C described later).

In the example illustrated in FIGS. 6A and 6B, the metal plate 20 including the overlapping portion 22b corresponds to an example of “first metal plate including first overlapping portion” according to the present disclosure, and the metal plate 30 including the overlapping portion 31b corresponds to an example of “second metal plate including second overlapping portion” according to the present disclosure. Further, in the example illustrated in FIGS. 6A and 6B, the number of the contact protrusions 27C is two, but may be one, or three or more.

A similar contact structure is applied between the metal plate 20 and the metal plate 40 as well, although description is simplified here. That is to say, the side wall portion 22 of the metal plate 20 and the side wall portion 41 of the metal plate 40 are provided with the overlapping portions 22b and 41b, respectively, which are overlapped with each other across the resin portion 14, as illustrated in FIG. 3. Part of the protrusions 27 on the side wall portion 22 side are also used as the contact protrusions 27C, and are in contact with the overlapping portion 41b. Note that in the relation between the metal plate 20 and the metal plate 40, the metal plate 20 and the metal plate 40 are referred to as corresponding to other examples of “first metal plate” and “second metal plate” according to the present disclosure, respectively.

In addition, the contact protrusions 27C are portions in which part of the overlapping portions 22b are raised by utilizing the arch shapes. However, when raising part of the overlapping portions 22b to form the contact protrusions, embossed forms without openings (see FIG. 6B) may be formed as contact protrusions instead of such arch shapes. The protrusions 27 included in the above-described engaged structure do not necessarily have to also serve as “contact protrusions” as in this example of the embossed shapes.

Also, although the above-described contact structure is provided on the side of the side wall portion 22 of the metal plate 20, the contact structure may alternatively be provided on the side of the other side wall portion 23, or on both side wall portions 22 and 23. Further, the “contact protrusions” according to the present disclosure may be provided on the sides of the overlapping portions 31b and 41b which are the portions extending to be overlapped with the overlapping portions 22b, instead of on the side of the metal plate 20.

### 1-2. Manufacturing Method of Battery Case

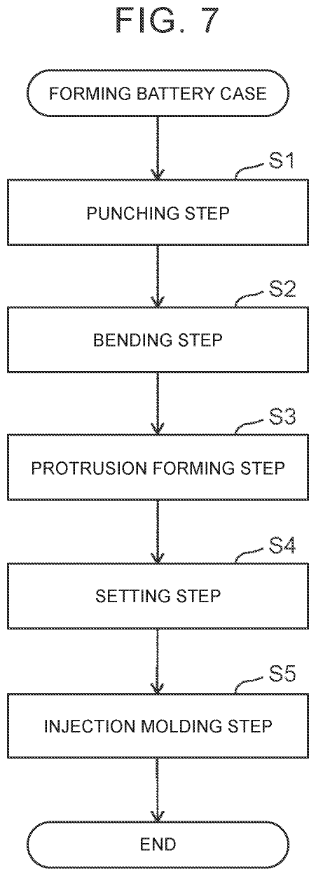

Next, a method of manufacturing the battery case 10 according to the present embodiment will be described with reference to FIGS. 7, 8A, 8B and 8C. FIG. 7 is a flowchart showing procedures of a manufacturing method of the battery case 10 according to the first embodiment. More specifically, FIG. 7 shows main steps for manufacturing (forming) the battery case 10 using stamping with a press machine and injection molding with an injection molding machine. FIGS. 8A, 8B and 8C are supplementary diagrams regarding formation of the contact protrusions 27C, and realization of the contact structure between the metal plates via the contact protrusions 27C.

First, in a punching step 51, a metal plate to serve as the source for each of the metal plates 20, 30, and 40 (i.e., a flat metal plate in which the metal plate 20 and so forth are unfolded) is formed from a hoop-shaped metal plate, by punching with a press machine. Note that the through holes 32 and 42 of the metal plates 30 and 40 may be formed at the same time in this punching step 51, or may be formed in another step thereafter.

Next, in a bending step S2, the metal plates 20, 30, and 40 are individually press molded by bending the parts of each metal plate obtained in the punching step 51 with a press machine. Note that in the example shown in FIG. 7, the combination of the punching step 51 and the bending step S2 corresponds to an example of “ press molding step ” according to one aspect of the present disclosure.

Next, in a protrusion forming step S3, the protrusions 24, 27, 33, and 43, including the contact protrusions 27C are press molded. Now, supplementary description will be made regarding the formation of the contact protrusions 27C, with reference to FIGS. 8A, 8B and 8C. The contact protrusions 27C are formed as illustrated in FIGS. 8A, 8B and 8C, by performing press molding on the metal plate 20 (side wall portion 22).

Next, in a setting step S4, the metal plates 20, 30, and 40 formed in the state illustrated in FIG. 3 are set in a mold of an injection molding machine. FIGS. 8A, 8B and 8C illustrate the metal plates 20 and 30 in the state of being set in the mold in this way. When the metal plates 20 and 30 are set in the mold in this way, the overlapping portion 31b rides up on the contact protrusions 27C. As a result, direct contact between the metal plate 20 and the metal plate 30 using the contact protrusions 27C is secured. This also applies to the relation between the metal plate 20 and the metal plate 40.

Next, in an injection molding step S5, the resin is injected (filled in) between the metal plates 20, 30, and 40 set in the setting step S4, and the resin portion 14 fixed to the metal plates 20, 30, and 40 is molded. As a result, the battery case 10 of the present embodiment is formed (manufactured).

### 1-3. Effects

As described above, in the battery case 10 according to the present embodiment, the metal plate 20 and the metal plate 30 connected across the resin portion 14 include the overlapping portions 22b and the overlapping portion 31b, respectively. The overlapping portion 31b is in direct contact with the contact protrusions 27C of the overlapping portion 22b. This also applies to the relation between the metal plate 20 and the metal plate 40. Such contact structures enable electrical conduction to be formed between the metal plates. Thus, grounding can be performed without providing a ground line for each metal plate. That is to say, only one ground line is needed.

Further, in the battery case 10, the overlapping portion 31b (second overlapping portion) is the portion provided by bending part of the metal plate 30 (second metal plate) for contact with the contact protrusions 27C. The height of the contact protrusions 27C is greater than the gap between the overlapping portion 22b (first overlapping portion) and the overlapping portion 31b, such that the overlapping portion 31b rides up on the contact protrusions 27C, as illustrated in FIGS. 8A, 8B and 8C. An arrangement may also be made in which the height of the contact protrusions 27C is the same as the size of the gap, instead of this example. Conversely, by setting the height to be larger than the gap, the overlapping portion 31b rides up on the contact protrusions 27C, and due to this, a force acts to press the overlapping portion 31b against the contact protrusions 27C upon the overlapping portion 31b that is a portion provided by bending part of the metal plate 30. Accordingly, contact (electrical conduction) between the metal plate 20 and the metal plate 30 can be performed in a sure way. This also applies to the relation between the metal plate 20 and the metal plate 40.

Further, in the battery case 10, the protrusions 27 that are provided on the metal plate 20 (first metal plate) and included in the above-mentioned engaged structure are the contact protrusions 27C. This enables securing contact between the metal plates without providing dedicated protrusions for the contact structure.

Also, in the manufacturing method of the battery case 10 according to the present embodiment, the contact protrusions 27C are formed by press molding. Instead of such a technique, the contact protrusions may be formed by joining a metal member to the metal plate 20 by another technique, such as welding, for example. Conversely, in the manufacturing method according to the present embodiment, the contact protrusions 27C can be formed simply by adding by adding the protrusion forming step S3 by press molding to the metal plate 20 formed by press molding. Accordingly, the battery case 10 in which contact between the metal plates is secured can be manufactured, while suppressing addition of manufacturing steps.

### 2. Second Embodiment

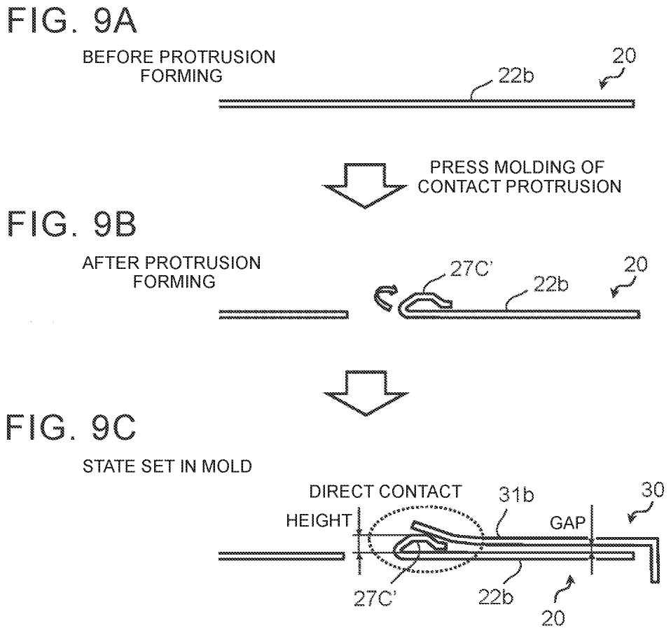

The second embodiment differs from the first embodiment with respect to the technique of forming the “contact protrusions”. FIGS. 9A, 9B and 9C are diagrams for describing a technique for forming contact protrusions 27C′ according to the second embodiment. As illustrated in FIGS. 9A, 9B and 9C, the contact protrusions 27C′ are portions provided by folding back part of the overlapping portion 22b (first overlapping portion) of the metal plate 20.

The contact protrusions 27C′ having a folded structure are formed by press molding in the protrusion forming step S3. More specifically, the contact protrusions 27C′ are formed by cutting and bending part of the overlapping portion 22b of the metal plate 20. Also, in the examples illustrated in FIGS. 9A, 9B and 9C, the height of the contact protrusions 27C′ is set to be larger than the gap between the overlapping portion 22b and the overlapping portion 31b, such that the overlapping portion 31b rides up on the contact protrusions 27C′, in the same way as the example in FIGS. 8A, 8B and 8C. In addition, the contact protrusions 27C′ that are folded back include openings as illustrated in FIGS. 9A, 9B and 9C, and the resin portion 14 is filled inside the openings, and accordingly it can be said that the contact protrusions 27C′ having the folded-back configuration also correspond to an example of the protrusions included in the above-described engaged structure. Accordingly, it can be said that with respect to the protrusions 27C′ as well, part of the protrusions included in the engaged structure are also contact protrusions.

Also, the three metal plates 20, 30, and 40 are not in direct contact with each other even in the completed state of the battery case 10 (lower case), and are disposed apart from each other (except for the positions of the contact protrusions 27C′, which is a feature structure of the battery case 10 according to the present embodiment) in the second embodiment as well.

### 3. Other Embodiments

In the above-described first and second embodiments, the metal plate portion 12 made up of the three metal plates 20, 30, and 40 is exemplified. However, the “metal plate portion” according to the present disclosure may be made up of two, or four or more metal plates. Further, it is sufficient for the metal plates to be configured such that the relation between the “first metal plate” and the “second metal plate” according to the present disclosure is satisfied between each pair of adjacent metal plates out of the metal plates, in order to secure electrical conduction between the metal plates.

What is claimed is:

1. A battery case configured to accommodate one or a plurality of battery cells, the battery case comprising:
a metal plate portion made up of a plurality of metal plates that is part of the battery case; and
a resin portion that is another part of the battery case, the resin portion connecting the metal plates by being interposed between the metal plates, wherein:
the metal plates include a first metal plate and a second metal plate;
the first metal plate includes a first overlapping portion and the second metal plate includes a second overlapping portion, the first overlapping portion and the second overlapping portion being overlapped with each other across the resin portion;
the first overlapping portion includes one or more contact protrusions protruding toward the second overlapping portion; and
the second overlapping portion is in direct contact with the one or more contact protrusions.

2. The battery case according to claim 1, wherein:
the second overlapping portion is a portion provided by bending part of the second metal plate such that the second overlapping portion is in contact with the one or more contact protrusions; and
a height of each of the one or more contact protrusions is larger than a gap between the first overlapping portion and the second overlapping portion, such that the second overlapping portion rides up on the one or more contact protrusions.

3. The battery case according to claim 1, further comprising an engaged structure in which the first metal plate and the resin portion are mechanically engaged, the engaged structure being configured to strengthen joining between the first metal plate and the resin portion, wherein the engaged structure includes one or more protrusions provided on the first metal plate, and the one or more protrusions are the one or more contact protrusions.

4. The battery case according to claim 1, wherein each of the one or more contact protrusions is a portion in which part of the first overlapping portion is raised.

5. The battery case according to claim 1, wherein each of the one or more contact protrusions is a portion provided by folding back part of the first overlapping portion.

6. The battery case according to claim 1, wherein the first metal plate and the second metal plate are disposed away from each other, except for one or more positions of the one or more contact protrusions.

7. The battery case according to claim 3, wherein:
each of the one or more protrusions includes an opening; and
the resin portion is filled inside of each of the one or more protrusions.

8. A manufacturing method of a battery case configured to accommodate one or a plurality of battery cells, wherein the battery case including
a metal plate portion made up of a plurality of metal plates that is part of the battery case, and
a resin portion that is another part of the battery case, the resin portion connecting the metal plates by being interposed between the metal plates, wherein:
the metal plates include a first metal plate and a second metal plate;
the first metal plate includes a first overlapping portion and the second metal plate includes a second overlapping portion, the first overlapping portion and the second overlapping portion being overlapped with each other across the resin portion;
the first overlapping portion includes one or more contact protrusions protruding toward the second overlapping portion; and
the second overlapping portion is in direct contact with the one or more contact protrusions,
the manufacturing method comprising:
a press molding step of molding the metal plates by press molding;
a protrusion forming step of molding the one or more contact protrusions by press molding;
a setting step of setting the metal plates in a mold following the press molding step and the protrusion forming step; and
an injection molding step of fabricating the battery case by filling in between the metal plates set in the mold with resin to mold the resin portion.

9. The manufacturing method of the battery case according to claim 8, wherein the first metal plate and the second metal plate are disposed away from each other, except for one or more positions of the one or more contact protrusions.
